(19) United States
(12) Patent Application Publication
(10) Pub. No.: US 2025/0379961 A1
(43) Pub. Date: Dec. 11, 2025

(54) COVER GLASS REFLECTION REMOVAL FROM STEREO IMAGES

(71) Applicant: Apple Inc., Cupertino, CA (US)

(72) Inventors: Mohammad Shafiei Rezvani Nezhad, Sunnyvale, CA (US); Maneli Noorkami, Menlo Park, CA (US); Afshin Taghavi Nasrabadi, Los Gatos, CA (US)

(21) Appl. No.: 19/227,813

(22) Filed: Jun. 4, 2025

Related U.S. Application Data
(60) Provisional application No. 63/657,486, filed on Jun. 7, 2024.

(51) Int. Cl. H04N 13/167; G06V 10/25; G06V 10/26; H04N 13/00; H04N 13/239; H04N 13/344

(52) U.S. Cl. CPC H04N 13/167; G06V 10/25; G06V 10/26; H04N 13/239; H04N 13/344; H04N 2013/0092; H04N 2013/0096

(57) ABSTRACT

Various implementations include devices, systems, and methods that reduce HMD cover glass-induced artifacts. For example, a process may obtain a reflection model for predicting image reflection locations based on an image light source location for images captured by light sources. The reflection model is generated based on camera positioning relative to the regions of the transparent structure and curvature of the regions of the transparent structure. The process identifies a light source region in a first image captured by a first camera of the HMD and predicts a reflection region in the first image based on the reflection model and the light source region. Replacement content for the first image is generated based on content from a second image captured by a second camera of the HMD and the first and second images are displayed such that the first image is provided with the replacement content replacing the reflection region.

### CROSS-REFERENCE TO RELATED APPLICATIONS

This application claims the benefit of U.S. Provisional Application Ser. No. 63/657,486 filed Jun. 7, 2024, which is incorporated herein in its entirety.

### TECHNICAL FIELD

The present disclosure generally relates to systems, methods, and devices that reduce head mounted device (HMD) cover glass-induced reflections and/or artifacts caused by outward-facing cameras capturing images through cover glass regions.

### BACKGROUND

Existing image artifact mitigation techniques may be improved with respect to simplicity, processing speed, and accuracy.

### SUMMARY

Various implementations disclosed herein include devices, systems, and methods that are configured to reduce HMD cover glass-induced reflections and/or artifacts caused by outward-facing cameras capturing images through cover glass, e.g., through curved cover glass regions. The reduction may involve using a stereo in-painting process. For example, pixels from a region of a right eye image may be utilized to cross-fill a corresponding region of a left eye image at which a reflection and/or artifact occurs. Likewise, the cover glass-induced reflection and/or artifact mitigation process may be used in instances where there are more than two images. In this instance, an algorithm may replace a reflection pixel with a corresponding pixel on any other images in the set. The cover glass-induced reflection and/or artifact mitigation process may include a first phase and a second phase. In another example, they may be only a single image (e.g., no stereo). In such instances, a reflection area may be in-painted (either by blurring, or other in-painting technique).

During a first phase occurring prior to HMD runtime (e.g., during an initial build process), a reflection model of an HMD cover glass may be generated for an HMD based on a geometry and/or curvature of the cover glass in combination with outward facing camera positions with respect to a geometry and/or curvature of the cover glass and camera extrinsic and intrinsic attributes (e.g., position, rotation, focal length, etc). Each different HMD model configuration may have its own reflection model. Alternatively, each individual HMD may have its own reflection model.

During a second phase occurring during HMD runtime, light source locations are detected within a first eye image (e.g., a left eye image). The light source locations may be used as input to the cover glass reflection model to predict reflection locations. For example, each light source pixel may be used to predict a reflection location. In some implementations, reflections occurring at the predicted reflection locations are mitigated via execution of an in-painting process that uses data from a corresponding region of a second eye image (e.g., a right eye image). For example, an image pixel from a right camera of the HMD may be reprojected at a predicted reflection point of a left camera of the HMD to replace a reflection with scene content. For example, in some implementations an in-painting process may enabled to be dependent on a correspondence detection method (e.g., optical flow, etc.) that locates a correspondence of each pixel of a left image within a right image. Likewise, reflection pixels of the left image may be looked up in right image by utilizing correspondence mapping. In the case of a single camera (e.g., non-stereo), in-painting may be performed by reproducing the scene structure from the same image or a machine learning in-painting method, as examples. In some implementations, an ML method may be used to predict a correspondence map given the left and right image.

The process may be implemented with respect to a spatial capture video and/or real time passthrough video.

In some implementations, light source locations may be detected via a light source segmentation structure that provides a mask identifying image pixels corresponding to light sources.

In some implementations, an HMD has a processor (e.g., one or more processors) that executes instructions stored in a non-transitory computer-readable medium to perform a method. The method performs one or more steps or processes. In some implementations, the HMD obtains a reflection model. The reflection model may be usable to predict image reflection locations based on image light source locations for images captured by a first camera of the HMD. The reflection model may be based on: (a) positioning of the first cameras relative to a region of the transparent structure; and (b) curvature of the region of the transparent structure. In some implementations, a light source region is identified in a first image captured by the first camera and a reflection region in the first image is predicted based on the reflection model and the light source region. In some implementations, replacement content for the reflection region in the first image is generated based on content from a second image captured by a second camera of the HMD. In some implementations, the first image and the second image are provided for display on one or more displays of the HMD such that the first image is provided with the replacement content replacing the reflection region.

In accordance with some implementations, a device includes one or more processors, a non-transitory memory, and one or more programs; the one or more programs are stored in the non-transitory memory and configured to be executed by the one or more processors and the one or more programs include instructions for performing or causing performance of any of the methods described herein. In accordance with some implementations, a non-transitory computer readable storage medium has stored therein instructions, which, when executed by one or more processors of a device, cause the device to perform or cause performance of any of the methods described herein. In accordance with some implementations, a device includes: one or more processors, a non-transitory memory, and means for performing or causing performance of any of the methods described herein.

### BRIEF DESCRIPTION OF THE DRAWINGS

So that the present disclosure can be understood by those of ordinary skill in the art, a more detailed description may be had by reference to aspects of some illustrative implementations, some of which are shown in the accompanying drawings.

FIG. 1 illustrates an exemplary electronic device operating in a physical environment corresponding to an extended reality (XR) environment, in accordance with some implementations.

FIG. 2 illustrates a left eye image and a right eye image displayed via an HMD, in accordance with some implementations.

FIG. 3 illustrates an image reflection removal process, in accordance with some implementations.

FIG. 4 illustrates a mask structure mapping light sources of an input image to a structure comprising predicted corresponding reflection regions, in accordance with some implementations.

FIG. 5 illustrates an HMD cover glass-induced reflections mitigation process, in accordance with some implementations.

FIG. 6A illustrates a light source grid and an associated light source/reflection point grid, in accordance with some implementations.

FIG. 6B is a flowchart representation of an exemplary method for creating a reflection model, in accordance with some implementations.

FIG. 7 is a flowchart representation of an exemplary method that reduces HMD cover glass-induced reflections and/or artifacts caused by outward-facing cameras capturing images through curved cover glass regions using a stereo in-painting process, in accordance with some implementations.

FIG. 8 is a block diagram of an electronic device of in accordance with some implementations.

In accordance with common practice the various features illustrated in the drawings may not be drawn to scale. Accordingly, the dimensions of the various features may be arbitrarily expanded or reduced for clarity. In addition, some of the drawings may not depict all of the components of a given system, method or device. Finally, like reference numerals may be used to denote like features throughout the specification and figures.

### DESCRIPTION

Numerous details are described in order to provide a thorough understanding of the example implementations shown in the drawings. However, the drawings merely show some example aspects of the present disclosure and are therefore not to be considered limiting. Those of ordinary skill in the art will appreciate that other effective aspects and/or variants do not include all of the specific details described herein. Moreover, well-known systems, methods, components, devices and circuits have not been described in exhaustive detail so as not to obscure more pertinent aspects of the example implementations described herein.

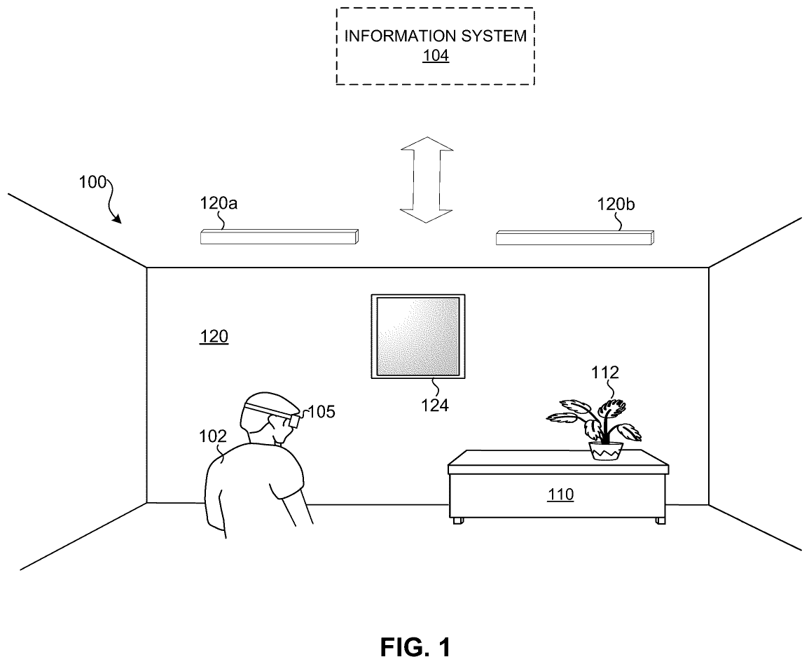

FIG. 1 illustrates an exemplary electronic device 105 operating in a physical environment 100 corresponding to an extended reality (XR) environment. Additionally, electronic device 105 may be in communication with an information system 104 (e.g., a device control framework or network). In an exemplary implementation, electronic device 105 is sharing information with the information system 104. In the example of FIG. 1, the physical environment 100 is a room that includes walls 120 and a window 124 and physical objects such as a desk 110, a light source 120a, a light source 120b, and a plant 112. The electronic device 105 may include one or more cameras, microphones, depth sensors, or other sensors that can be used to capture information about and evaluate the physical environment 100 and the objects within it, as well as information about the user 102 of electronic device 105. The information about the physical environment 100 and/or user 102 may be used to provide visual and audio content and/or to identify the current location of the physical environment 100 and/or the location of the user within the physical environment 100.

In some implementations, views of an extended reality (XR) environment may be provided to one or more participants (e.g., user 102 and/or other participants not shown) via electronic device 105 (e.g., a wearable device such as an HMD). Such an XR environment may include views of a 3D environment that is generated based on camera images and/or depth camera images of the physical environment 100 as well as a representation of user 102 based on camera images and/or depth camera images of the user 102. Such an XR environment may include virtual content that is positioned at 3D locations relative to a 3D coordinate system associated with the XR environment, which may correspond to a 3D coordinate system of the physical environment 100.

In some implementations, an HMD (e.g., device 105), optionally communicatively coupled a server, or other external device (e.g., information system 104) may be configured to obtain a reflection model(s) configured to predict image reflection locations based on image light source locations for images that capture light sources such as, inter alia, light source 120a, light source 120b, and/or lighting (e.g., sunlight) from window 124. The HMD includes a transparent structure (e.g., a curved cover glass structure) and cameras configured to capture images of an environment around the HMD through regions of the transparent structure. The reflection model(s) may be generated based on positioning of cameras (of the HMD) with respect to the regions and an associated curvature of the transparent structure. For example, a reflection model may provide a mapping or machine learning (ML) model configured to provide a prediction such that when a pixel in an image corresponds to a light source, a related pixel in the image may exhibit a reflection (e.g., a pixel-to-pixel mapping).

In some implementations, a light source region(s) (e.g., pixels) in a first image captured by a first camera of the HMD may be identified. For example, the light source region may be identified via a light source segmentation process that utilizes a mask to identify image pixels corresponding to light sources (e.g., light source 120a, light source 120b, and/or lighting (e.g., sunlight) from window 124).

In some implementations, a reflection region(s) (e.g., pixels) in the first image is identified based on the reflection model(s) and the light source region(s) and replacement content for the reflection region(s) in the first image is generated based on content from a second image captured by a second camera of the HMD. Subsequently, the first image and the second image may be displayed (via a display of the HMD) with the replacement content replacing the reflection region(s) thereby providing an image viewing experience without any reflections or artifacts. In the case of a single image (e.g., non-stereo), replacement content may be generated based on the structures in the rest of the image.

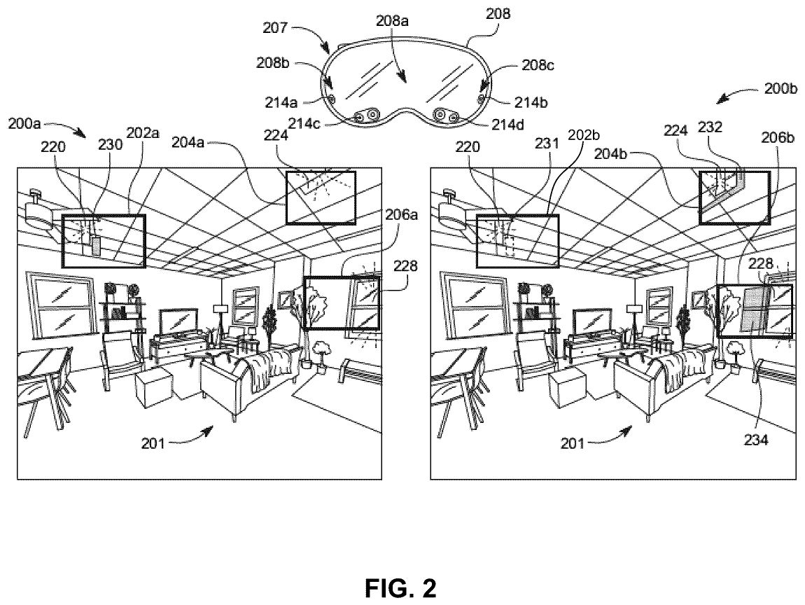

FIG. 2 illustrates a left eye image 200a and a right eye image 200b displayed via an HMD 207 comprising left outward facing camera 214a, left downward facing camera 214c, right outward facing camera 214b, and right downward facing camera 214d, in accordance with some implementations.

Left eye image 200a illustrates a view of a physical (or XR) environment corresponding to a left eye view of a user (e.g., user 102 of FIG. 1) associated with left outward facing camera 214a (or left downward facing camera 214c). Left eye image 200a comprises a view of objects 201 (e.g., furniture, a TV, etc.) and lighting regions 202a, 204a, and 206a of the physical (or XR) environment. Lighting region 202a illustrates a light source 220 (e.g., an overhead light) and a reflection region 230 (e.g., a reflection of light produced from light source 220) caused by left outward facing camera 214a being placed on HMD 207 with respect to a high curvature region 208b (e.g., a peripheral regions) of a cover glass structure 208 of HMD 207 thereby directing a view of light source 220 via camera 214a through high curvature region 208b. Lighting region 204a illustrates a light source 224 (e.g., an overhead light) without a reflection region as camera 214a is placed on HMD 207 such that a view of light source 224 via camera 214a is directed through region 208a and a reflection of region 208a overlays light source 224 and therefore a reflection region does not appear as an artifact since the light source 224 region is already over exposed. Likewise, lighting region 206a illustrates a light source 228 (e.g., a window associated with natural light such as the sun) without a reflection region as camera 214a is placed on HMD 207 such that a view of light source 234 via camera 214a is directed through region 208a and a reflection of region 208a overlays light source 234 and therefore a reflection region does not appear as an artifact since the light source 234 region is already over exposed.

Right eye image 200b illustrates a view of the physical (or XR) environment corresponding to a right eye view of the user associated with right outward facing camera 214b (or right downward facing camera 214d). Right eye image 200b comprises a view of objects 201 (e.g., furniture, a TV, etc.) and lighting regions 202b, 204b, and 206b (i.e., right eye lighting region versions with respect to lighting regions 202a, 204a, and 206a of left eye image 200a) of the physical (or XR) environment. In contrast with left eye image 200a, lighting region 202b (presented via right eye image 200b) illustrates light source 220 without a reflection region as camera 214b is placed on HMD 207 such that a view of light source 220 via camera 214b is directed through a region 208a and a reflection of region 208a overlays light source 220 and therefore a reflection region does not appear as an artifact since the light source 220 region is already over exposed. Likewise in contrast with left eye image 200a, lighting region 204b (presented via right eye image 200b) illustrates light source 224 and a reflection region 232 (e.g., a reflection of light produced from light source 224) caused by right outward facing camera 214b being placed on HMD 207 with respect to a high curvature region 208c of cover glass structure 208 of HMD 207 thereby directing a view of light source 224 via camera 214b through high curvature region 208c. Similarly, lighting region 206b (presented via right eye image 200b) illustrates light source 228 and a reflection region 234 (e.g., a reflection of light, such as sunlight, produced from light source 228) caused by right outward facing camera 214b being placed on HMD 207 with respect to high curvature region 208c of cover glass structure 208 of HMD 207 thereby directing a view of light source 228 via camera 214b through high curvature region 208c.

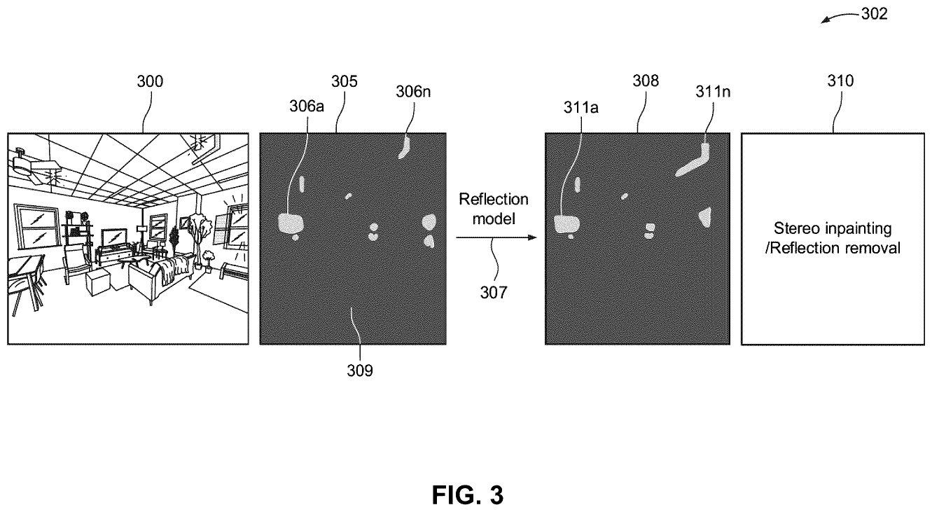

In some implementations, reflection regions 230, 232, and 234 may be mitigated via usage of a stereo in-painting process that utilizes pixels (e.g., of pixel region 231) from a camera image (e.g., right camera image 202b) that does not have a reflection region (e.g., lighting region 202b) and paints and copies the pixel information (of pixel region 231) into the reflection region (e.g., reflection region 230) to reduce or eliminate reflections or artifacts in the images as further described with respect to FIG. 3, infra. For example, in some implementations an in-painting process may enabled to be dependent on a correspondence detection method (e.g., optical flow, etc.) that locates a correspondence of each pixel of a left image within a right image. Likewise, reflection pixels of the left image may be looked up in right image by utilizing correspondence mapping. In some implementations, an ML method may be used to predict a correspondence map given the left and right image. In the case of a single camera (e.g., non-stereo), in-painting may be performed by reproducing the scene structure from the same image or via a machine learning in-painting method, as examples.

FIG. 3 illustrates an image reflection removal process 302, in accordance with some implementations. Reflection removal process 302 determines light source locations within an (input) image 300 (e.g., right eye image 200b of FIG. 2) via light source segmentation that provides a mask structure 305 identifying image pixels corresponding to light sources. For example, process 302 detects light source locations within image 300 by identifying regions (e.g., pixels) of image 300 that are overexposed or significantly brighter than surrounding regions. The overexposed regions are determined to correspond to light sources such as, light sources 220, 224, 228, etc. as described with respect to FIG. 2, supra. In response to detecting the light source locations within image 300, a mask structure 305 is generated (via light source segmentation) for identifying pixels in image 300 corresponding to the detected light sources. Mask structure 305 (e.g., a binary mask) illustrates pixel regions 306a . . . 306n identified as light sources and pixel regions 309 (shaded regions) representing regions that are not considered light sources.

Subsequently, mask structure 305 analyzed with respect to a reflection model 307 to generate an output mask 308 representing predicted reflection regions 311a . . . 311n associated with light source regions (e.g., pixels 306a . . . 306n) represented in mask structure 305. Reflection model 307 comprises a model associated with a geometry and curvature an HMD cover glass structure (e.g., cover glass structure 208 of FIG. 2) with respect to a camera geometry of the HMD. For example, reflection model may include camera extrinsic attributes (e.g., position, rotation, etc.) and intrinsic attributes (e.g., focal length, sensor position, etc.). In some implementations, reflection model 307 may be generated by sampling point light sources to determine how light travels from the point light sources, interacts with portions of a curved surface of a cover glass structure of an HMD, and reflects off the portions of the curved surface towards HMD cameras. In some implementations, output mask 308 may analyze factors such as angles of incidence, surface properties such as reflectivity, and a position of light sources. Each different HMD model configuration (or each individual device) may have its own reflection model.

In some implementations, predicted reflection regions 311a . . . 311n may be in-painted using data from a corresponding region of an eye image differing from input image 300 (e.g., left eye image 200a of FIG. 2) based on a pixel-to-pixel mapping between the images. For example, an image pixel(s) (or pixel region) from left eye image 200a (of FIG. 2) may be reprojected at a predicted reflection point of right eye image 200b (of FIG. 2) to replace a reflection or artifact with scene content thereby removing the refection from the image. In-painting may be performed by reproducing the scene structure from the same image or a machine learning in-painting method, for example, in the case of a single camera (e.g., non-stereo).

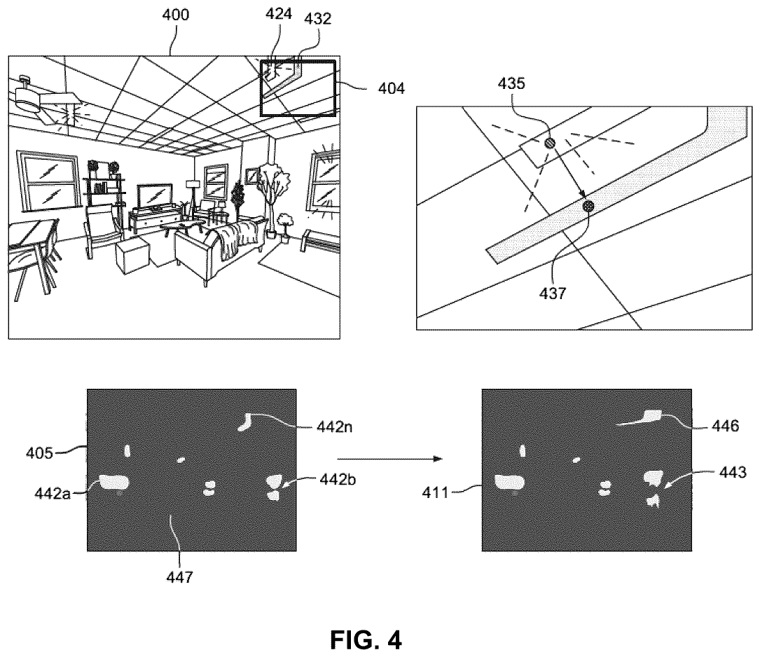

FIG. 4 illustrates a mask structure 405 mapping light sources of an input image 400 to a reflection mask 411 comprising predicted corresponding reflection regions 443 and 446, in accordance with some implementations. Mask structure 405 illustrates pixel regions (e.g., pixel regions 442a . . . 442n) identified as light sources and pixel regions (shaded region 447) representing regions that are not considered light sources. For example, mask structure 405 comprises a pixel region 442n representing a light source 424 of a lighting region 404. Likewise, reflection mask 411 comprises a reflection region 446 associated with pixel region 442n representing reflection 432 of input image 400. Close up view of lighting region 404 illustrates pixel mapping of pixels (e.g., pixel 435) of light source 424 to a predicted pixel region (e.g., predicted pixel region 437) of reflection region 432 (e.g., a reflection of light produced from light source 424) via usage of mask structure 405 mapping light sources 442a . . . 442n to reflection regions 446 and 443 of reflection mask 411.

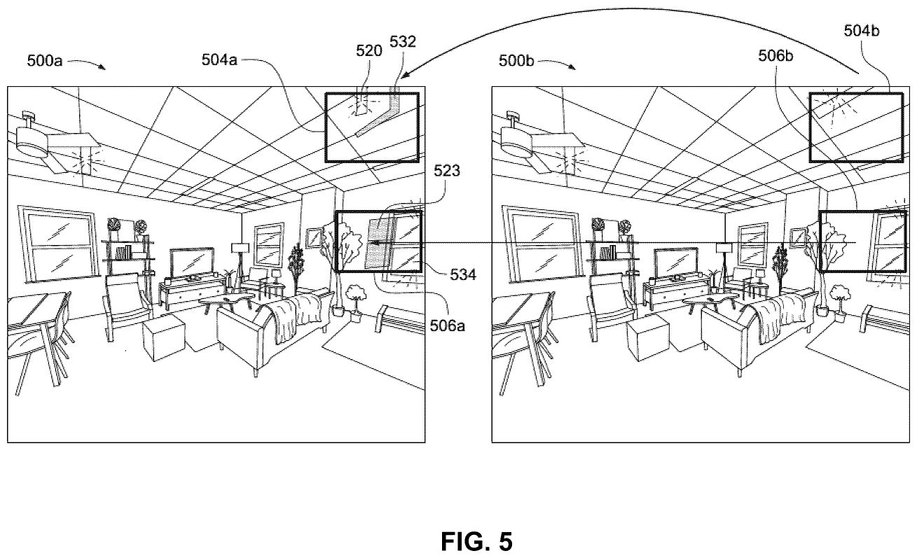

FIG. 5 illustrates HMD cover glass-induced reflections mitigation process executed between a left eye image 500a and a right eye image 500b, in accordance with some implementations. Left eye image 500a illustrates a region 504a comprising a light source 520 (e.g., an overhead light) and a reflection region 532 (e.g., a reflection of light produced from light source 520) caused by an outward facing camera being placed on an HMD with respect to a high curvature region (e.g., a peripheral regions) of a cover glass structure of an HMD thereby directing a view of light source 520 via the camera through the high curvature region as described with respect to FIG. 2, supra. Likewise, region 506a illustrates a light source 534 (e.g., a window associated with natural light such as the sun) and a reflection region 523 (e.g., a reflection of light produced from light source 534) caused by an outward facing camera being placed on an HMD with respect to a high curvature region of the cover glass structure of an HMD thereby directing a view of light source 534 via the camera through the high curvature region as described with respect to FIG. 2, supra.

In some implementations, reflection region 532 may be resolved (e.g., in-painted) using data (i.e., pixels) from a corresponding region 504b of right eye image 500b. For example, an image pixel(s) (or pixel region) from corresponding region 504b may be reprojected at a predicted corresponding reflection point of reflection region 532 to replace reflection portions with scene content (i.e., a pixel(s)) thereby removing the reflection region 532 from image 500a. Likewise, reflection region 523 may be resolved (e.g., in-painted) using data (i.e., pixels) from a corresponding region 506b of right eye image 500b. For example, an image pixel(s) (or pixel region) from corresponding region 504b may be reprojected at a predicted corresponding reflection point of reflection region 532 to replace a reflection portion with scene content (i.e., a pixel(s)) thereby removing the reflection region 532 from image 500a. In some implementations, reflection region 532 might be replaced by an average of the neighboring pixels (e.g., on a homogenously painted wall). A mono in-painting process may be performed by reproducing the scene structure from the same image or via a machine learning in-painting method, as examples.

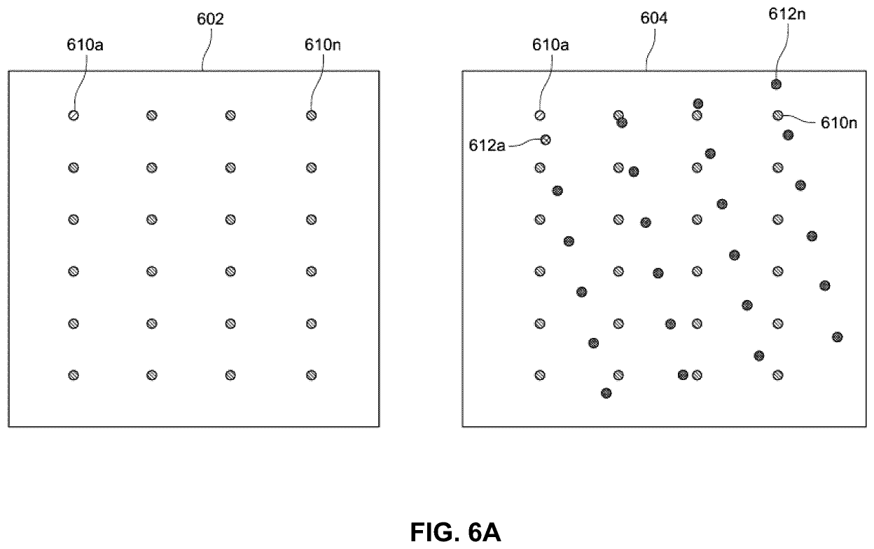

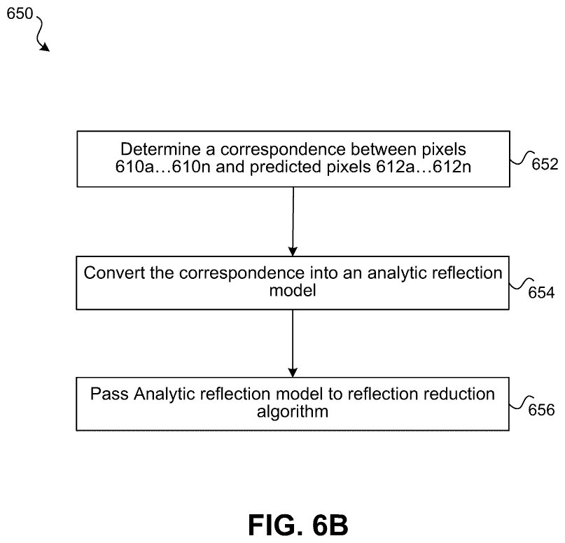

FIG. 6A illustrates sampling of cover glass reflections corresponding to a light source grid 602 and an associated light source/reflection point grid 604, in accordance with some implementations. Light source grid 602 represents a grid of pixels 610a . . . 610n associated with light sources. Light source/reflection point grid 604 represents pixels 610a . . . 610n (subsequent to being turned on) and a grid of predicted reflection point pixels 612a . . . 612n associated with pixels 610a . . . 610n of light sources.

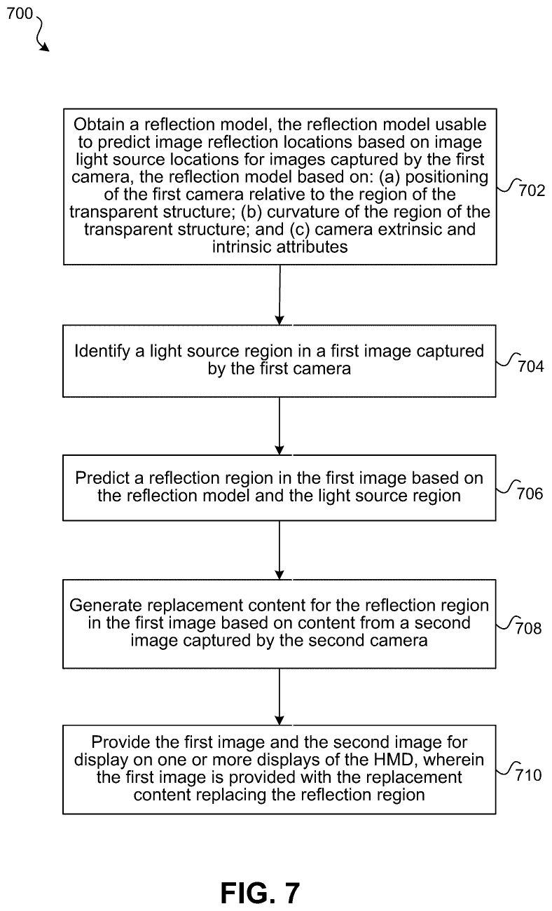

FIG. 6B is a flowchart representation of an exemplary method 650 for creating a reflection model, in accordance with some implementations. For example, the method 650 uses the sampling of cover glass reflections (e.g., described with respect to FIG. 6A) to create an analytic reflection model. At block 652, the method 650 determines a correspondence between pixels 610a . . . 610n and pixels 612a . . . 612n. The correspondence may be determined via, for example, a pixel mapping process. At block 654, the method 650 converts the correspondence into an analytic reflection model such as, for example, a surface normal map where each pixel has a vector. At block 656, the method 650 passes the analytic reflection model to a reflection reduction algorithm to reduce HMD cover glass-induced reflections and/or artifacts as described with respect to FIG. 7, infra.

FIG. 7 is a flowchart representation of an exemplary method 700 that reduces HMD cover glass-induced reflections and/or artifacts caused by outward-facing cameras capturing images through curved cover glass regions using a stereo in-painting process, in accordance with some implementations. In some implementations, the method 700 is performed by a device(s), such as a tablet device, mobile device, desktop, laptop, HMD, server device, information system, etc. In some implementations, the device has a screen for displaying images and/or a screen for viewing stereoscopic images such as a head-mounted display (HMD such as e.g., electronic device 105 of FIG. 1). In some implementations, the device (e.g., an HMD) includes a transparent structure (such as curved cover glass structure 208 as described with respect to FIG. 2) a first camera configured to capture images of an environment around the HMD through a region of the transparent structure, and a second camera configured to capture images of the environment around the HMD. In some implementations, the method 700 is performed by processing logic, including hardware, firmware, software, or a combination thereof. In some implementations, the method 700 is performed by a processor executing code stored in a non-transitory computer-readable medium (e.g., a memory). Each of the blocks in the method 700 may be enabled and executed in any order.

At block 702, the method 700 obtains a reflection model (e.g., the analytic reflection model of step 656 of FIG. 6B or from an optical formulation of an HMD cover glass) usable to predict image reflection locations (e.g., reflection regions 230, 232, and 234 as illustrated in FIG. 2) based on image light source locations for images captured by the first camera such as camera 214a as illustrated in FIG. 2. The reflection model may be generated based on: positioning of the first camera relative to the region of the transparent structure; a curvature of the region of the transparent structure; and camera extrinsic and intrinsic attributes as described with respect to HMD 207 illustrated in FIG. 2.

In some implementations, the reflection model provides pixel-to-pixel mapping with respect to single pixels as described with respect to FIG. 4.

In some implementations, the reflection model provides pixel-to-pixel mapping with respect to an image region comprising blocks of pixels such as pixel region 442 illustrated in FIG. 4.

In some implementations, the transparent structure is a curved cover glass structure formed over the left camera and the right camera.

In some implementations, the reflection model is generated for the transparent structure. In some implementations, the reflection model is generated for multiple structures comprising a related structure type with respect to the transparent structure.

At block 704, the method 700 identifies a light source region (e.g., pixels) in a first image captured by the first camera. In some implementations, identifying the light source region in the first image may be performed via a light source segmentation process (as described with respect to FIG. 3) with respect to the light source region. The light source segmentation process may provide a mask identifying image pixels (e.g., overexposed pixels) corresponding to light sources of the light source region.

At block 706, the method 700 predicts a reflection region (e.g., refection regions 311 as illustrated in FIG. 3) in the first image based on the reflection model and the light source region. In some implementations, the reflection model provides at least one mapping structure configured to be executed to predict, with respect to a first pixel in the first image corresponding to a first light source of the light source region, that a second pixel in the first image will exhibit a reflection of the reflection region.

In some implementations, the reflection model may provide at least one machine learning (ML) model configured to be executed to predict, with respect to a first pixel in the first image corresponding to a first light source of the light source region, that a second pixel in the first image will exhibit a reflection of the reflection region. For example, in some implementations an in-painting process may enabled to be dependent on a correspondence detection method (e.g., optical flow, etc.) that locates a correspondence of each pixel of a left image within a right image. Likewise, reflection pixels of the left image may be looked up in right image by utilizing correspondence mapping. In some implementations, an ML method may be used to predict a correspondence map given the left and right image.

At block 708, the method 700 generates replacement content for the reflection region in the first image based on content from a second image captured by a second camera of the one or more cameras. In some implementations, generating the replacement content for the reflection region in the first image may include: at each reflection point of the reflection region, reprojecting a corresponding pixel from the second image to the first image as described with respect to FIG. 2 or from the same image, e.g., in the case of a single camera. In some implementations, in-painting may replace reflection pixels with an average of the neighboring pixels without a reflection if corresponding pixels on the second image are not located. The first image and the second image may be associated with spatial capture video and/or real time passthrough video.

At block 710, the method 700 provides the first image and the second image for display on one or more displays of the HMD. The first image may be provided with the replacement content replacing the one or more reflection regions.

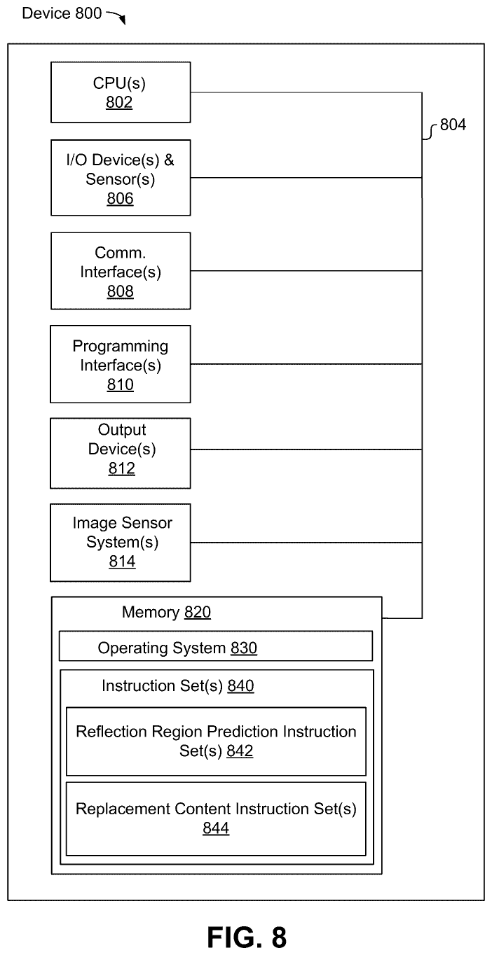

FIG. 8 is a block diagram of an example device 800. Device 800 illustrates an exemplary device configuration for electronic device 105 of FIG. 1. While certain specific features are illustrated, those skilled in the art will appreciate from the present disclosure that various other features have not been illustrated for the sake of brevity, and so as not to obscure more pertinent aspects of the implementations disclosed herein. To that end, as a non-limiting example, in some implementations the device 800 includes one or more processing units 802 (e.g., microprocessors, ASICs, FPGAs, GPUs, CPUS, processing cores, and/or the like), one or more input/output (I/O) devices and sensors 804, one or more communication interfaces 808 (e.g., USB, FIREWIRE, THUNDERBOLT, IEEE 802.3x, IEEE 802.11x, IEEE 802.14x, GSM, CDMA, TDMA, GPS, IR, BLUETOOTH, ZIGBEE, SPI, I2C, and/or the like type interface), one or more programming (e.g., I/O) interfaces 810, output devices (e.g., one or more displays) 812, one or more interior and/or exterior facing image sensor systems 814, a memory 820, and one or more communication buses 804 for interconnecting these and various other components.

In some implementations, the one or more communication buses 804 include circuitry that interconnects and controls communications between system components. In some implementations, the one or more I/O devices and sensors 806 include at least one of an inertial measurement unit (IMU), an accelerometer, a magnetometer, a gyroscope, a thermometer, one or more physiological sensors (e.g., blood pressure monitor, heart rate monitor, blood oxygen sensor, blood glucose sensor, etc.), one or more microphones, one or more speakers, a haptics engine, one or more depth sensors (e.g., a structured light, a time-of-flight, or the like), one or more cameras (e.g., inward facing cameras and outward facing cameras of an HMD), one or more infrared sensors, one or more heat map sensors, and/or the like.

In some implementations, the one or more displays 812 are configured to present a view of a physical environment, a graphical environment, an extended reality environment, etc. to the user. In some implementations, the one or more displays 812 are configured to present content (determined based on a determined user/object location of the user within the physical environment) to the user. In some implementations, the one or more displays 812 correspond to holographic, digital light processing (DLP), liquid-crystal display (LCD), liquid-crystal on silicon (LCoS), organic light-emitting field-effect transitory (OLET), organic light-emitting diode (OLED), surface-conduction electron-emitter display (SED), field-emission display (FED), quantum-dot light-emitting diode (QD-LED), micro-electromechanical system (MEMS), and/or the like display types. In some implementations, the one or more displays 812 correspond to diffractive, reflective, polarized, holographic, etc. waveguide displays. In one example, the device 800 includes a single display. In another example, the device 800 includes a display for each eye of the user.

In some implementations, the one or more image sensor systems 814 are configured to obtain image data that corresponds to at least a portion of the physical environment 100. For example, the one or more image sensor systems 814 include one or more RGB cameras (e.g., with a complimentary metal-oxide-semiconductor (CMOS) image sensor or a charge-coupled device (CCD) image sensor), monochrome cameras, IR cameras, depth cameras, event-based cameras, and/or the like. In various implementations, the one or more image sensor systems 814 further include illumination sources that emit light, such as a flash. In various implementations, the one or more image sensor systems 814 further include an on-camera image signal processor (ISP) configured to execute a plurality of processing operations on the image data.

In some implementations, sensor data may be obtained by device(s) (e.g., devices 105 and 110 of FIG. 1) during a scan of a room of a physical environment. The sensor data may include a 3D point cloud and a sequence of 2D images corresponding to captured views of the room during the scan of the room. In some implementations, the sensor data includes image data (e.g., from an RGB camera), depth data (e.g., a depth image from a depth camera), ambient light sensor data (e.g., from an ambient light sensor), and/or motion data from one or more motion sensors (e.g., accelerometers, gyroscopes, IMU, etc.). In some implementations, the sensor data includes visual inertial odometry (VIO) data determined based on image data. The 3D point cloud may provide semantic information about one or more elements of the room. The 3D point cloud may provide information about the positions and appearance of surface portions within the physical environment. In some implementations, the 3D point cloud is obtained over time, e.g., during a scan of the room, and the 3D point cloud may be updated, and updated versions of the 3D point cloud obtained over time. For example, a 3D representation may be obtained (and analyzed/processed) as it is updated/adjusted over time (e.g., as the user scans a room).

In some implementations, sensor data may be positioning information, some implementations include a VIO to determine equivalent odometry information using sequential camera images (e.g., light intensity image data) and motion data (e.g., acquired from the IMU/motion sensor) to estimate the distance traveled. Alternatively, some implementations of the present disclosure may include a simultaneous localization and mapping (SLAM) system (e.g., position sensors). The SLAM system may include a multidimensional (e.g., 3D) laser scanning and range-measuring system that is GPS independent and that provides real-time simultaneous location and mapping. The SLAM system may generate and manage data for a very accurate point cloud that results from reflections of laser scanning from objects in an environment. Movements of any of the points in the point cloud are accurately tracked over time, so that the SLAM system can maintain precise understanding of its location and orientation as it travels through an environment, using the points in the point cloud as reference points for the location.

In some implementations, the device 800 includes an eye tracking system for detecting eye position and eye movements (e.g., eye gaze detection). For example, an eye tracking system may include one or more infrared (IR) light-emitting diodes (LEDs), an eye tracking camera (e.g., near-IR (NIR) camera), and an illumination source (e.g., an NIR light source) that emits light (e.g., NIR light) towards the eyes of the user. Moreover, the illumination source of the device 800 may emit NIR light to illuminate the eyes of the user and the NIR camera may capture images of the eyes of the user. In some implementations, images captured by the eye tracking system may be analyzed to detect position and movements of the eyes of the user, or to detect other information about the eyes such as pupil dilation or pupil diameter. Moreover, the point of gaze estimated from the eye tracking images may enable gaze-based interaction with content shown on the near-eye display of the device 800.

The memory 820 includes high-speed random-access memory, such as DRAM, SRAM, DDR RAM, or other random-access solid-state memory devices. In some implementations, the memory 820 includes non-volatile memory, such as one or more magnetic disk storage devices, optical disk storage devices, flash memory devices, or other non-volatile solid-state storage devices. The memory 820 optionally includes one or more storage devices remotely located from the one or more processing units 802. The memory 820 includes a non-transitory computer readable storage medium.

In some implementations, the memory 820 or the non-transitory computer readable storage medium of the memory 820 stores an optional operating system 830 and one or more instruction set(s) 840. The operating system 830 includes procedures for handling various basic system services and for performing hardware dependent tasks. In some implementations, the instruction set(s) 840 include executable software defined by binary information stored in the form of electrical charge. In some implementations, the instruction set(s) 840 are software that is executable by the one or more processing units 802 to carry out one or more of the techniques described herein.

The instruction set(s) 840 includes a reflection region prediction instruction set 842 and a replacement content instruction set 844. The instruction set(s) 840 may be embodied as a single software executable or multiple software executables.

The reflection region prediction instruction set 842 is configured with instructions executable by a processor to predict reflection regions (e.g., pixels) in an image based on one or more reflection models and one or more light source regions.

The replacement content instruction set 844 is configured with instructions executable by a processor to generate replacement content for one or more reflection regions in a first image based on content from a second image captured by a camera.

Although the instruction set(s) 840 are shown as residing on a single device, it should be understood that in other implementations, any combination of the elements may be located in separate computing devices. Moreover, FIG. 8 is intended more as functional description of the various features which are present in a particular implementation as opposed to a structural schematic of the implementations described herein. As recognized by those of ordinary skill in the art, items shown separately could be combined and some items could be separated. The actual number of instructions sets and how features are allocated among them may vary from one implementation to another and may depend in part on the particular combination of hardware, software, and/or firmware chosen for a particular implementation.

Those of ordinary skill in the art will appreciate that well-known systems, methods, components, devices, and circuits have not been described in exhaustive detail so as not to obscure more pertinent aspects of the example implementations described herein. Moreover, other effective aspects and/or variants do not include all of the specific details described herein. Thus, several details are described in order to provide a thorough understanding of the example aspects as shown in the drawings. Moreover, the drawings merely show some example embodiments of the present disclosure and are therefore not to be considered limiting.

While this specification contains many specific implementation details, these should not be construed as limitations on the scope of any inventions or of what may be claimed, but rather as descriptions of features specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Thus, particular embodiments of the subject matter have been described. Other embodiments are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking and parallel processing may be advantageous.

Embodiments of the subject matter and the operations described in this specification can be implemented in digital electronic circuitry, or in computer software, firmware, or hardware, including the structures disclosed in this specification and their structural equivalents, or in combinations of one or more of them. Embodiments of the subject matter described in this specification can be implemented as one or more computer programs, e.g., one or more modules of computer program instructions, encoded on computer storage medium for execution by, or to control the operation of, data processing apparatus. Alternatively, or additionally, the program instructions can be encoded on an artificially generated propagated signal, e.g., a machine-generated electrical, optical, or electromagnetic signal, that is generated to encode information for transmission to suitable receiver apparatus for execution by a data processing apparatus. A computer storage medium can be, or be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially generated propagated signal. The computer storage medium can also be, or be included in, one or more separate physical components or media (e.g., multiple CDs, disks, or other storage devices).

The term “data processing apparatus” encompasses all kinds of apparatus, devices, and machines for processing data, including by way of example a programmable processor, a computer, a system on a chip, or multiple ones, or combinations, of the foregoing. The apparatus can include special purpose logic circuitry, e.g., an FPGA (field programmable gate array) or an ASIC (application specific integrated circuit). The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures. Unless specifically stated otherwise, it is appreciated that throughout this specification discussions utilizing the terms such as “processing,” “computing,” “calculating,” “determining,” and “identifying” or the like refer to actions or processes of a computing device, such as one or more computers or a similar electronic computing device or devices, that manipulate or transform data represented as physical electronic or magnetic quantities within memories, registers, or other information storage devices, transmission devices, or display devices of the computing platform.

The system or systems discussed herein are not limited to any particular hardware architecture or configuration. A computing device can include any suitable arrangement of components that provides a result conditioned on one or more inputs. Suitable computing devices include multipurpose microprocessor-based computer systems accessing stored software that programs or configures the computing system from a general purpose computing apparatus to a specialized computing apparatus implementing one or more implementations of the present subject matter. Any suitable programming, scripting, or other type of language or combinations of languages may be used to implement the teachings contained herein in software to be used in programming or configuring a computing device.

Implementations of the methods disclosed herein may be performed in the operation of such computing devices. The order of the blocks presented in the examples above can be varied for example, blocks can be re-ordered, combined, and/or broken into sub-blocks. Certain blocks or processes can be performed in parallel. The operations described in this specification can be implemented as operations performed by a data processing apparatus on data stored on one or more computer-readable storage devices or received from other sources.

The use of “adapted to” or “configured to” herein is meant as open and inclusive language that does not foreclose devices adapted to or configured to perform additional tasks or steps. Additionally, the use of “based on” is meant to be open and inclusive, in that a process, step, calculation, or other action “based on” one or more recited conditions or values may, in practice, be based on additional conditions or value beyond those recited. Headings, lists, and numbering included herein are for ease of explanation only and are not meant to be limiting.

It will also be understood that, although the terms “first,” “second,” etc. may be used herein to describe various elements, these elements should not be limited by these terms. These terms are only used to distinguish one element from another. For example, a first node could be termed a second node, and, similarly, a second node could be termed a first node, which changing the meaning of the description, so long as all occurrences of the “first node” are renamed consistently and all occurrences of the “second node” are renamed consistently. The first node and the second node are both nodes, but they are not the same node.

The terminology used herein is for the purpose of describing particular implementations only and is not intended to be limiting of the claims. As used in the description of the implementations and the appended claims, the singular forms “a,” “an,” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

As used herein, the term “if” may be construed to mean “when” or “upon” or “in response to determining” or “in accordance with a determination” or “in response to detecting,” that a stated condition precedent is true, depending on the context. Similarly, the phrase “if it is determined [that a stated condition precedent is true]” or “if [a stated condition precedent is true]” or “when [a stated condition precedent is true]” may be construed to mean “upon determining” or “in response to determining” or “in accordance with a determination” or “upon detecting” or “in response to detecting” that the stated condition precedent is true, depending on the context.

What is claimed is:

1. A method comprising:
at a processor of a head-mounted device (HMD) comprising a transparent structure, a first camera configured to capture images of an environment around the HMD through a region of the transparent structure, and a second camera configured to capture images of the environment around the HMD:
obtaining a reflection model, the reflection model usable to predict image reflection locations based on image light source locations for images captured by the first camera, the reflection model based on: (a) positioning of the first camera relative to the region of the transparent structure; (b) curvature of the region of the transparent structure; and (c) camera extrinsic and intrinsic attributes;
identifying a light source region in a first image captured by the first camera;
predicting a reflection region in the first image based on the reflection model and the light source region;
generating replacement content for the reflection region in the first image based on content from a second image captured by the second camera; and
providing the first image and the second image for display on one or more displays of the HMD, wherein the first image is provided with the replacement content replacing the reflection region.

2. The method of claim 1, wherein the reflection model provides at least one mapping structure configured to be executed to predict, with respect to a first pixel in the first image corresponding to a first light source of the light source region, that a second pixel in the first image will exhibit a reflection of the reflection region.

3. The method of claim 1, wherein the reflection model provides at least one machine learning (ML) model configured to be executed to predict, with respect to a first pixel in the first image corresponding to a first light source of the light source region, that a second pixel in the first image will exhibit a reflection of the reflection region.

4. The method of claim 1, wherein the reflection model provides pixel-to-pixel mapping with respect to single pixels.

5. The method of claim 1, wherein the reflection model provides pixel-to-pixel mapping with respect image regions comprising blocks of pixels.

6. The method of claim 1, wherein said identifying the light source region in the first image is performed via a light source segmentation process with respect to the light source region.

7. The method of claim 6, wherein the light source segmentation process provides a mask identifying image pixels corresponding to light sources of the light source region.

8. The method of claim 7, wherein the image pixels are overexposed pixels.

9. The method of claim 1, wherein said generating the replacement content for the reflection region in the first image comprises:
at each reflection point of the reflection region, reprojecting a corresponding pixel from the second image to the first image.

10. The method of claim 1, wherein the transparent structure is a curved cover glass structure formed over the left camera and the right camera.

11. The method of claim 1, wherein the reflection model is generated for the transparent structure.

12. The method of claim 1, wherein the reflection model is generated for multiple structures comprising a related structure type with respect to the transparent structure.

13. The method of claim 1, wherein the first image and the second image are associated with spatial capture video.

14. The method of claim 1, wherein the first image and the second image are associated with real time passthrough video.

15. A non-transitory computer-readable medium comprising instructions that when executed by a processor cause the processor to perform operations comprising:
obtaining a reflection model, the reflection model usable to predict image reflection locations based on image light source locations for images captured by the first camera, the reflection model based on: (a) positioning of the first camera relative to the region of the transparent structure; (b) curvature of the region of the transparent structure; and (c) camera extrinsic and intrinsic attributes;
identifying a light source region in a first image captured by the first camera;
predicting a reflection region in the first image based on the reflection model and the light source region;
generating replacement content for the reflection region in the first image based on content from a second image captured by the second camera; and
providing the first image and the second image for display on one or more displays of the HMD, wherein the first image is provided with the replacement content replacing the reflection region.

16. A head mounted device (HMD) comprising:
a transparent structure and two or more cameras configured to capture images of an environment around the HMD through regions of the transparent structure;
a non-transitory computer-readable storage medium; and
one or more processors coupled to the non-transitory computer-readable storage medium, wherein the non-transitory computer-readable storage medium comprises program instructions that, when executed on the one or more processors, cause the electronic device to perform operations comprising:
obtaining a reflection model, the reflection model usable to predict image reflection locations based on image light source locations for images captured by the first camera, the reflection model based on: (a) positioning of the first camera relative to the region of the transparent structure; (b) curvature of the region of the transparent structure;
and (c) camera extrinsic and intrinsic attributes;
identifying a light source region in a first image captured by the first camera;
predicting a reflection region in the first image based on the reflection model and the light source region;
generating replacement content for the reflection region in the first image based on content from a second image captured by the second camera; and
providing the first image and the second image for display on one or more displays of the HMD, wherein the first image is provided with the replacement content replacing the reflection region.

17. The HMD of claim 16, wherein the reflection model provides at least one mapping structure configured to be executed to predict, with respect to a first pixel in the first image corresponding to a first light source of the light source region, that a second pixel in the first image will exhibit a reflection of the reflection region.

18. The HMD of claim 16, wherein the reflection model provides at least one machine learning (ML) model configured to be executed to predict, with respect to a first pixel in the first image corresponding to a first light source of the light source region, that a second pixel in the first image will exhibit a reflection of the reflection region.

19. The HMD of claim 16, wherein the reflection model provides pixel-to-pixel mapping with respect to single pixels.

20. The HMD claim 16, wherein the reflection model provides pixel-to-pixel mapping with respect image regions comprising blocks of pixels.
